(19) United States
(12) Patent Application Publication
(10) Pub. No.: US 2021/0309013 A1
(43) Pub. Date: Oct. 7, 2021

(54) INKJET RECORDING APPARATUS

(71) Applicant: KYOCERA Document Solutions Inc, Osaka-shi (JP)

(72) Inventor: Kimihiko KOBAYASHI, Osaka-shi (JP)

(21) Appl. No.: 17/223,194

(22) Filed: Apr. 6, 2021

(30) Foreign Application Priority Data
Apr. 7, 2020 (JP) 2020-069251

(51) Int. Cl. B41J 2/165; B41J 2/14; B41J 11/00; B41J 11/46

(52) U.S. Cl. CPC B41J 2/16585; B41J 2/14; B41J 2202/20; B41J 2/16526; B41J 11/46; B41J 11/007

(57) ABSTRACT

A controller of an inkjet recording apparatus determines whether waste is adhered around the periphery of the openings of the conveyor belt based on the detection result of the surface state detection sensor before and after the recording head executes flushing. Then, and based on the presence or absence of waste and a previously set placement pattern of the recording medium to be supplied onto the conveyor belt, in the cycle following the cycle in which the flushing was executed, the controller causes the supply of the recording medium onto the conveyor belt by the recording medium supply mechanism to execute or stop in the following cycle.

### INCORPORATION BY REFERENCE

This application is based upon, and claims the benefit of priority from, corresponding Japanese Patent Application No. 2020-069251 filed in the Japan Patent Office on Apr. 7, 2020, the entire contents of which are incorporated herein by reference.

### BACKGROUND

### Field of the Invention

The present disclosure relates to an inkjet recording apparatus that ejects ink onto a recording medium and records an image.

### Description of Related Art

Conventionally, in an inkjet recording apparatus such as an inkjet printer, flushing (empty ejection) is performed by periodically ejecting ink from the nozzle in order to reduce or prevent clogging of the nozzle due to drying of the ink.

### SUMMARY

An inkjet recording apparatus for an aspect of present disclosure includes a recording head having a plurality of nozzles that eject ink, an endless conveyor belt that conveys a recording medium to a position facing the recording head, a recording medium supply mechanism that supplies the recording medium onto the conveyor belt, a surface state detection sensor that detects a surface state of the conveyor belt, and a controller that controls the recording medium supply mechanism. The conveyor belt has a plurality of openings in the conveyance direction of the recording medium that allow the ink to pass through when the recording head executes flushing, ejecting ink at times different from the times that contribute to image formation on the recording medium. Based on the detection result of the surface state detection sensor before and after the recording head executes flushing, the controller determines whether waste is adhered around the periphery of the openings of the conveyor belt and based on the presence or absence of waste and a previously set placement pattern of the recording medium to be supplied onto the conveyor belt in the cycle following the cycle in which the flushing was executed, to cause the supply of the recording medium onto the conveyor belt by the recording medium supply mechanism to execute or to stop in the following cycle.

### BRIEF DESCRIPTION OF THE DRAWINGS

FIG. 1 is an explanatory diagram schematically illustrating a configuration of a printer as an inkjet recording apparatus according to an embodiment of the present disclosure;

FIG. 2 is a plan view of a recording unit included in the printer;

FIG. 3 is an explanatory diagram schematically illustrating a configuration around a paper conveyance path from a paper feed cassette of the printer to a second conveyance unit via a first conveyance unit;

FIG. 4 is a block diagram illustrating the hardware configuration of the main part of the printer;

FIG. 5 is a plan view illustrating an example of a configuration of a first conveyor belt included in the first conveyance unit;

FIG. 6 is an explanatory diagram schematically illustrating an example of a pattern of an opening group for flushing when the first conveyor belt of FIG. 5 is in use, and paper is arranged on the first conveyor belt according to the pattern;

FIG. 7 is an explanatory diagram schematically illustrating another example of a pattern and paper arranged on the first conveyor belt according to the pattern;

FIG. 8 is an explanatory diagram schematically illustrating yet another example of a pattern and paper arranged on the first conveyor belt according to the pattern;

FIG. 9 is an explanatory diagram schematically illustrating yet another example of a pattern and paper arranged on the first conveyor belt according to the pattern; and

FIG. 10 is a flowchart showing the flow of processing by control of supply of the paper to the first conveyor belt.

### DETAILED DESCRIPTION

1. Configuration of Inkjet Recording Apparatus

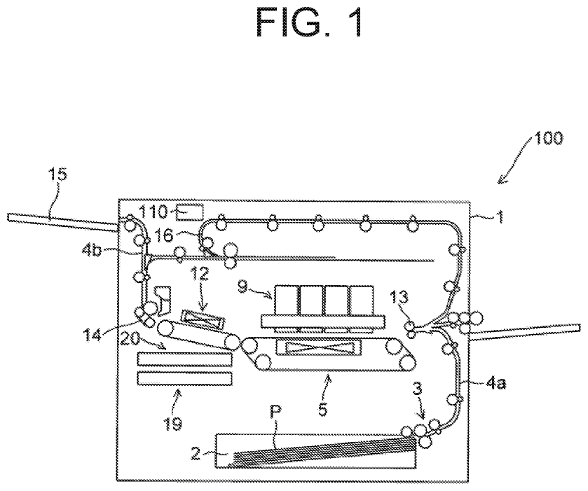

Hereinafter, embodiments of the present disclosure will be described with reference to the accompanying drawings. FIG. 1 is an explanatory diagram illustrating a schematic configuration of a printer 100 as an inkjet recording apparatus according to an embodiment of the present disclosure. The printer 100 includes a paper feed cassette 2 which is a paper storage unit. The paper feed cassette 2 is arranged in the lower inside portion of the printer main body 1. Paper P, which is an example of a recording medium, is stored inside the paper feed cassette 2.

The paper feeder 3 is arranged on the downstream side of the paper feed cassette 2 in the paper conveyance direction, that is, above the right side of the paper feed cassette 2 in FIG. 1. The paper feeder 3, separates and sends out the paper P sheet by sheet toward the upper right side of the paper feed cassette 2 in FIG. 1.

The printer 100 includes a first paper conveyance path 4a inside the printer 100. The first paper conveyance path 4a is positioned on the upper right side of the paper feed cassette 2 in the paper feed direction. The paper P sent out from the paper feed cassette 2 is conveyed vertically upward along the side surface of the printer main body 1 by the first paper conveyance path 4a.

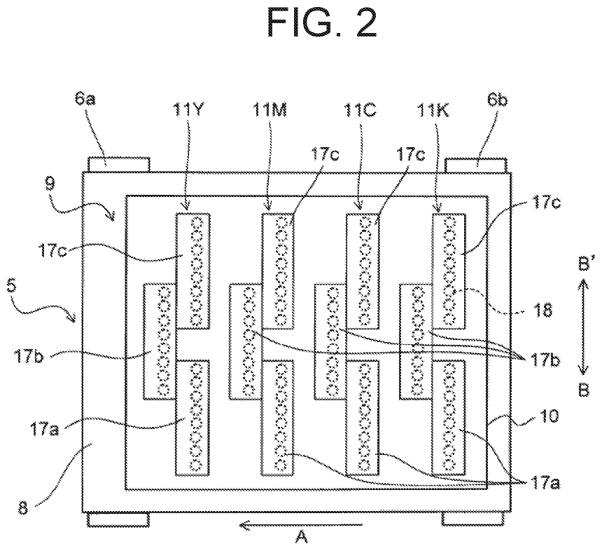

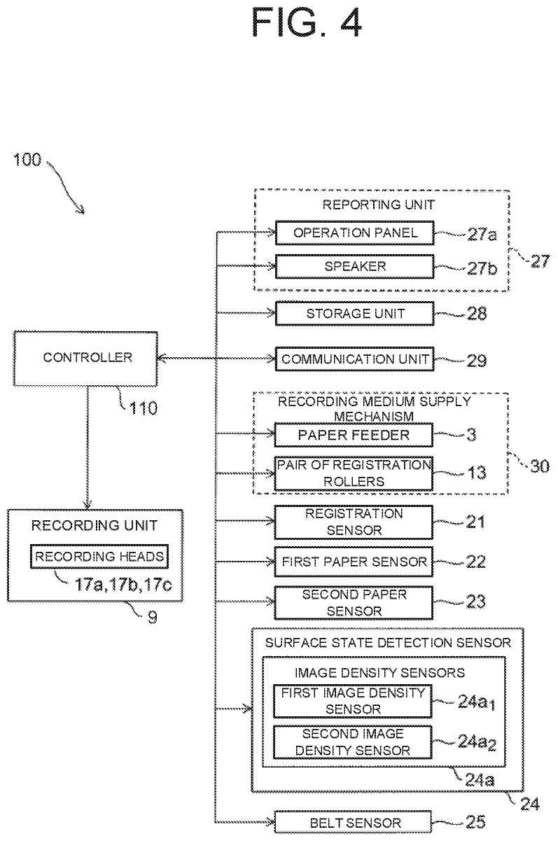

A pair of registration rollers 13 is provided at the downstream end of the first paper conveyance path 4a in the paper conveyance direction. Further, the first conveyance unit 5 and the recording unit 9 are arranged in the immediate vicinity of the pair of registration rollers 13 on the downstream side in the paper conveyance direction. The paper P sent out from the paper feed cassette 2 reaches the pair of registration rollers 13 through the first paper conveyance path 4a. The pair of registration rollers 13 correct tilt of the paper P during sending, measure the times of the ink ejection operation executed by the recording unit 9, and send the paper P toward the first conveyance unit 5. The paper feeder 3 and the pair of registration rollers 13 constitute the recording medium supply mechanism 30 (see FIG. 4) which supplies the paper P in the paper feed cassette 2 onto the first conveyor belt 8 (see FIG. 2) described below in the first conveyance unit 5.

The paper P sent to the first conveyance unit 5 is conveyed by the first conveyor belt 8 to a position facing the recording unit 9 (particularly, the recording heads 17a to 17c described later). An image is recorded on the paper P by ink ejected from the recording unit 9 onto the paper P. At this time, the ink ejection in the recording unit 9 is controlled by the controller 110 inside the printer 100. The controller 110 is configured, for example, by a central processing unit (CPU).

In the paper conveyance direction, the second conveyance unit 12 is arranged on the downstream side (left side in FIG. 1) of the first conveyance unit 5. The paper P, on which the image is recorded by the recording unit 9 is sent to the second conveyance unit 12. The ink ejected onto the surface of the paper P dries while passing through the second conveyance unit 12.

In the paper conveyance direction, a decurling section 14 is provided on the downstream side of the second conveyance unit 12 and near the left side surface of the printer main body 1. The paper P whose ink has been dried by the second conveyance unit 12 is sent to the decurling section 14, and the curl that has occurred on the paper P is corrected.

A second paper conveyance path 4b is provided on the downstream side (upward in FIG. 1) of the decurling section 14 in the paper conveyance direction. When double-sided recording is not performed, the paper P that has passed through the decurling section 14 passes through the second paper conveyance path 4b and is discharged to the paper discharge tray 15 provided on the outer left side surface of the printer 100.

A reverse conveyance path 16 for double-sided recording is provided above the recording unit 9 and the second conveyance unit 12 in the upper part of the printer main body 1. When double-sided recording is performed, after the recording on one side (the first side) of the paper P is ended, the paper P that has passed through the second conveyance unit 12 and the decurling section 14 passes through the second paper conveyance path 4b and is sent to the reverse conveyance path 16.

The paper P sent to the reverse conveyance path 16 is subsequently turned over in the conveyance direction for recording on the other side (the second side) of the paper P. Then, the paper P passes through the upper part of the printer main body 1 and is sent toward the right side, and is sent to the first conveyance unit 5 again and through the pair of registration rollers 13 in a state where the second side is facing upward. In the first conveyance unit 5, the paper P is conveyed to a position facing the recording unit 9, and an image is recorded on the second surface by ink ejected from the recording unit 9. After double-sided recording, the paper P is discharged through the second conveyance unit 12, the decurling section 14, and the second paper conveyance path 4b to the paper discharge tray 15 in order.

A maintenance unit 19 and a cap unit 20 are arranged below the second conveyance unit 12. The maintenance unit 19 moves horizontally below the recording unit 9 when purging is executed, wipes the ink pushed out from the ink ejection port of the recording head, and collects the wiped ink. Purging refers to an operation of forcibly pushing out ink from the ink ejection port of the recording head in order to discharge thickened ink, foreign matter, and air bubbles from the ink ejection port. When capping the ink ejection surface of the recording head, the cap unit 20 moves horizontally below the recording unit 9, then moves upward to mount to the lower surface of the recording head.

FIG. 2 is a plan view of the recording unit 9. The recording unit 9 includes a head housing 10 and line heads 11Y, 11M, 11C, and 11K. The line heads 11Y to 11K are held in the head housing 10 and are formed to have a specific interval of height (for example, 1 mm) with respect to the conveyance surface of the endless first conveyor belt 8 stretched on a plurality of rollers including the drive roller 6a, the driven roller 6b, and the other rollers 7. The driving of the drive roller 6a is controlled by the controller 110.

The line heads 11Y to 11K each have a plurality of (three in this example) recording heads 17a to 17c. The recording heads 17a to 17c are arranged in a staggered manner along the paper width direction (the direction of arrow BB′), which is orthogonal to the paper conveyance direction (the direction of arrow A). The recording heads 17a to 17c have a plurality of ink ejection ports 18 (nozzles). The ink ejection ports 18 are arranged side by side at equal intervals in the width direction of the recording head, that is, in the paper width direction (the direction of arrow BB′). The line heads 11Y to 11K eject inks of each color of yellow (Y), magenta (M), cyan (C), and black (K) through the ink ejection ports 18 of the recording heads 17a to 17c and toward the paper P conveyed by the first conveyor belt 8.

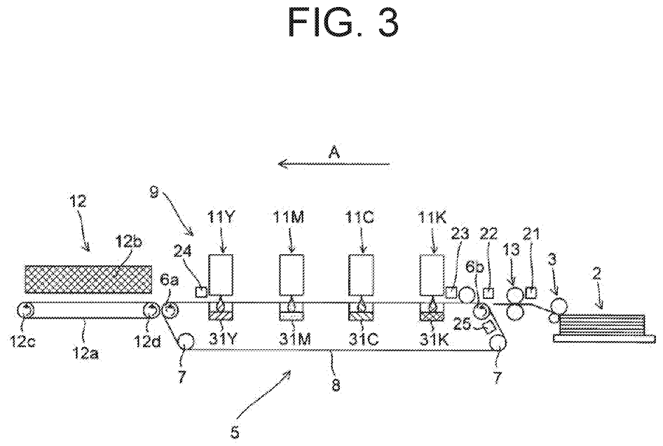

FIG. 3 schematically illustrates the configuration around the conveyance path of the paper P from the paper feed cassette 2 to the second conveyance unit 12 via the first conveyance unit 5. Further, FIG. 4 is a block diagram illustrating a hardware configuration of a main part of the printer 100. In addition to the above configuration, the printer 100 further includes a registration sensor 21, a first paper sensor 22, a second paper sensor 23, a surface state detection sensor 24 and a belt sensor 25.

The registration sensor 21 detects the paper P that is conveyed from the paper feed cassette 2 by the paper feeder 3 and sent to the pair of registration rollers 13. The controller 110 can control the rotational start time of the pair of registration rollers 13 based on the detection result of the registration sensor 21. For example, based on the detection result of the registration sensor 21, the controller 110 can control the supply time of the paper P to the first conveyor belt 8 after skew (tilt) correction by the pair of registration rollers 13.

The first paper sensor 22 is a sensor that detects the position in the width direction of the paper P sent from the pair of registration rollers 13 to the first conveyor belt 8. Based on the detection result of the first paper sensor 22, from among the ink ejection ports 18 corresponding to the recording heads 17a to 17c of the line heads 11Y to 11K, the controller 110 can cause ink to be ejected from the ink ejection ports 18 in the width direction of the paper P and an image can be recorded on the paper P.

The second paper sensor 23 is a sensor that detects the passage of the paper P supplied to the first conveyor belt 8 by the pair of registration rollers 13. That is, the second paper sensor 23 detects the position of the paper P conveyed by the first conveyor belt 8 in the conveyance direction. The second paper sensor 23 is positioned on the upstream side of the recording unit 9 and on the downstream side of the first paper sensor 22 in the paper conveyance direction. Based on the detection result of the second paper sensor 23, the controller 110 controls the ink ejection times with respect to the paper P reaching a position facing the line heads 11Y to 11K (recording heads 17a to 17c) by the first conveyor belt 8.

The surface state detection sensor 24 detects the surface state of the first conveyor belt 8. The surface state detection sensor 24 includes an image density sensor 24a. also known as an ID sensor.

The image density sensor 24a is configured with, for example, a light-emitting element and a light-receiving element, and when light emitted from the light-emitting element is reflected by the surface of an object, light is received by the light-receiving element. The amount of light received by the light receiving element varies depending on the state of the surface of the object (for example, the presence or absence of adhered ink). Accordingly, the controller 110 can determine, for example, whether the surface of the object has ink waste or the like by comparing the amount of light received by the light-receiving element of the surface state detection sensor 24 with a standard amount of light received (for example, the amount of light-received when there is no adhered ink).

The above-described image density sensor 24a is originally provided on the downstream side in the paper conveyance direction in relation to the recording heads 17a-17c, in order to detect the presence or absence of the paper P on the first conveyor belt 8. Light is emitted from the light emitting element of the image density sensor 24a, and the amount of light received by the light receiving element of the light reflected by the surface of the first conveyor belt 8 and the amount of light received by the light receiving element of the light emitted from the light emitting element and reflected by the surface of the paper P placed on the first conveyor belt 8 are different from each other. Therefore, the image density sensor 24a can detect whether paper P is placed on the first conveyor belt 8 based on the amount of light received by the light receiving element.

Also, the image density sensor 24a is configured with a first image density sensor 24a₁ and a second image density sensor 24a₂.

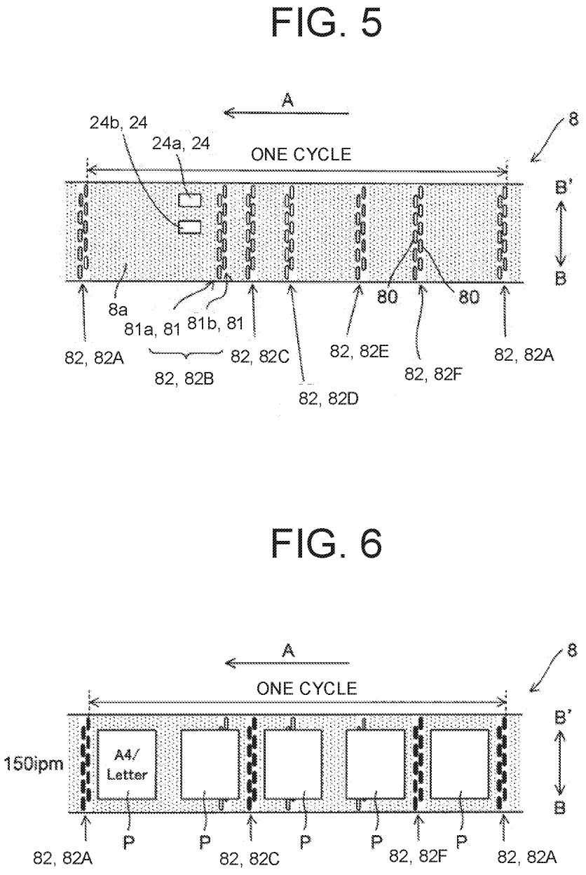

The first image density sensor 24a₁ and the second image density sensor 24a₂ are arranged (see FIG. 5) in line in the paper width direction (the direction of the arrow BB′ in FIG. 2, or the belt width direction). In this way, the image density sensor 24a can also detect skew of the paper P based on a gap in the detection times of the paper P at the first image density sensor 24a₁ and the second image density sensor 24a₂.

The belt sensor 25 detects the position of the plurality of opening groups 82 (see FIG. 5), which will be described later, in the first conveyor belt 8. The surface state detection sensor 24 described above may also detect the position of the opening group 82 and the openings 80 in the first conveyor belt 8 with a light emitting element and a light receiving element.

The belt sensor 25 is positioned between the driven roller 6b and the other rollers 7 on which the first conveyor belt 8 is stretched. The driven roller 6b is positioned on the upstream side in the traveling direction of the first conveyor belt 8 with respect to the recording unit 9. Based on the detection result of the surface state detection sensor 24 or the belt sensor 25, the controller 110 can control the pair of registration rollers 13 so as to supply the paper P to the first conveyor belt 8 at a specific time.

Further, the position of the paper is detected by a plurality of sensors (second paper sensor 23, surface state detection sensor 24), and the position of the opening group 82 of the first conveyor belt 8 is detected by the plurality of sensors (surface state detection sensor 24 and belt sensor 25), so that it is possible to correct the error of the detected position and detect an abnormality.

The first paper sensor 22, the second paper sensor 23, and the belt sensor 25 described above may be configured as transmissive or reflective optical sensors, or contact image sensors (CIS sensors). Further, a mark corresponding to the position of the opening group 82 may be formed at an end of the first conveyor belt 8 in the width direction, and the surface state detection sensor 24 and belt sensor 25 may detect the position of the opening group 82 by detecting this mark.

In addition, the printer 100 may be provided with a curve detection sensor that detects curving of the first conveyor belt 8, and may be configured to correct the curving of the first conveyor belt 8 based on the detection result.

The printer 100 further includes a reporting unit 27, a storage unit 28, and a communication unit 29. The reporting unit 27 is provided for reporting information to the outside. This reporting unit 27 comprises an operation panel 27a and a speaker 27b. The operation panel 27a includes, for example, a liquid crystal display, and reports information to the outside with the display. The speaker 27b reports information to the outside by outputting vocal sound or a regular sound (for example, a buzzer).

The operation panel 27a is an operation unit that receives various setting inputs by the user. For example, the user can operate the operation panel 27a to input information on the size the size of the paper P to be set in the paper feed cassette 2, that is, the size of the paper P to be conveyed by the first conveyor belt 8.

The storage unit 28 is a memory device that stores the operation program of the controller 110 along with various information, and is configured by including read only memory (ROM), random access memory, (RAM), a non-volatile memory, and the like. The information set by the operation panel 27a (for example, the size information of the paper P) is stored in the storage unit 28. The communication unit 29 is a communication interface for transmitting and receiving information to and from the outside (for example, a personal computer (PC)). For example, when a user operates a PC and sends a print command together with image data to the printer 100, the image data and the print command are input to the printer 100 via the communication unit 29. In the printer 100, the controller 110 controls the recording heads 17a to 17c based on the image data to eject ink so that the image can be recorded on the paper P.

Further, as illustrated in FIG. 3, the printer 100 has ink receptacles 31Y, 31M, 31C, and 31K on the inner peripheral surface side of the first conveyor belt 8. When flushing is executed by the recording heads 17a to 17c, the ink receptacles 31Y to 31K receive and collect the ink discharged from the recording heads 17a to 17c and passed through the openings 80 (see FIG. 5) of the opening group 82, described later, of the first conveyor belt 8. Therefore, the ink receptacles 31Y to 31K are provided at positions facing the recording heads 17a to 17c of the line heads 11Y to 11K through the first conveyor belt 8. The ink collected by the ink receptacles 31Y to 31K is sent to, for example, a waste ink tank, and discarded, or the ink may be reused without being discarded.

Here, flushing means ink ejection from the ink ejection port 18 at times different from the times that contribute to image formation (image recording) on the paper P for the purpose of reducing or preventing clogging of the ink ejection port 18 due to drying of the ink. The execution of flushing in the recording heads 17a to 17c is controlled by the controller 110.

The above-mentioned second conveyance unit 12 includes a second conveyor belt 12a and a dryer 12b. The second conveyor belt 12a is stretched on two driving rollers 12c and a driven roller 12d. The paper P is conveyed by the first conveyance unit 5, an image is recorded on the paper by ink ejection by the recording unit 9, the paper P is conveyed by the second conveyor belt 12a, dried by the dryer 12b during conveyance, and conveyed to the decurling section 14 described above.

2. Details of the First Conveyor Belt

2-1. Example of Configuration of the First Conveyor Belt

Next, the details of the first conveyor belt 8 of the first conveyance unit 5 will be described. FIG. 5 is a plan view illustrating an example of a configuration of the first conveyor belt 8. In the present embodiment, a negative pressure suction method is used in which the paper P is conveyed by attraction to the first conveyor belt 8 through negative pressure suction. Therefore, the first conveyor belt 8 is provided with innumerable suction holes 8a that allow passage of the suctioned air generated by the negative pressure suction.

Further, the first conveyor belt 8 is also provided with an opening group 82. The opening group 82 is a set of openings 80 which allow passage of ink ejected from each nozzle (ink ejection port 18) of the recording heads 17a to 17c during flushing. The opening area of one opening 80 is larger than the opening area of one suction hole 8a. The first conveyor belt 8 has, in one cycle, a plurality of opening groups 82 in the conveyance direction (A direction) of the paper P, and the present embodiment has six groups. Note that one cycle refers to a time period or distance in which the first conveyor belt 8 makes one revolution. When each opening group 82 is distinguished from one another, the six opening groups 82 are referred to as opening groups 82A to 82F from the downstream side in the A direction. The suction holes 8a are positioned between each opening group 82 and the adjacent opening group 82 in the A direction. This means that in the first conveyor belt 8, the suction holes 8a are not formed in a region (around the periphery of the openings 80) coinciding with an opening group 82.

The opening groups 82 are irregularly positioned in the A direction in one cycle of the first conveyor belt 8. That is, in the A direction, the interval between an opening group 82 and an adjacent opening group 82 is not constant but variable (there are at least two types of the above intervals). At this time, the maximum distance between the two opening groups 82 adjacent to each other in the A direction (for example, the distance between the opening group 82A and the opening group 82B in FIG. 8) is longer than the length of the paper P of the minimum printable size (for example, A4 size (horizontally placed)) in the A direction when it is placed on the first conveyor belt 8.

The opening group 82 has an opening row 81. The opening row 81 is configured by arranging a plurality of openings 80 in the belt width direction (paper width direction, BB′ direction) orthogonal to the A direction. One opening group 82 has at least one opening row 81 in the A direction, and in the present embodiment, has two opening rows 81. To distinguish the two opening rows 81 from each other, one row is referred to as the opening row 81a and the other row is referred to as the opening row 81b.

In one opening group 82, the openings 80 of any opening row 81 (for example, opening row 81a) are positioned to be offset in the BB′ direction with respect to the openings 80 of the other opening row 81 (for example, opening row 81b). and are positioned to appear to overlap with a portion of the openings 80 of another opening row 81 (for example, opening row 81b) when viewed along the A direction. Further, in each opening row 81, the plurality of openings 80 are positioned at equal intervals in the BB′ direction.

By arranging the plurality of opening rows 81 in the A direction to form one opening group 82 as described above, the width of the opening group 82 in the BB′ direction is longer than the width of the recording heads 17a to 17c in the BB′ direction. Therefore, the opening group 82 covers the entire ink ejection region of the recording heads 17a to 17c in the BB′ direction, and the ink ejected from all the ink ejection ports 18 of the recording heads 17a to 17c during flushing passes through any opening 80 of the opening group 82.

Also, as shown in FIG. 5, an image density sensor 24a among one of the above-described image density sensors 24a (e.g., the first image density sensor 24a₁) is arranged in a position to detect the surface state of the conveyor belt 8 around the periphery of the openings 80 of one opening row 81a from among the two opening rows 81a and 81b that are adjacent to each other in the paper conveyance direction.

Then, another surface state detection sensor 24a (e.g., the second image density sensor 24a₂) is installed in a position to detect the surface state around the periphery of the openings 80 included in another opening row 81b of the first conveyor belt 8.

Although the detection area of the image density sensor 24a is narrow, if the ink is ejected at the same time from each of the ink ejection ports 18 in the head width direction (corresponding to the belt width direction) of the recording heads 17a to 17c, the adhesion of ink around the periphery of the openings 80 is considered to occur in the same manner for any openings 80 in the belt width direction. For this reason, there is not a problem even if the image density sensor 24a only detects the surface state of the first conveyor belt 8 in a portion of the belt width direction.

The image density sensor 24a may include a single image density sensor. In this case, the single image density sensor 24a may be arranged, for example, at a position where the surface state around the openings 80 of one opening row 81a and the surface state around the openings 80 of the other opening row 81b are simultaneously detected (on an extended line in the A direction from the position where the openings 80 of each row appear to overlap one another when viewed along the A direction).

2-2. Pattern of Opening Groups Used During Flushing

In the present embodiment, the controller 110 drives the recording heads 17a to 17c to record an image on the paper P based on the image data transmitted from the outside (for example, a PC) while the first conveyor belt 8 conveys the paper P. At that time, by causing the recording heads 17a to 17c to execute flushing (flushing between sheets) between the conveyed paper P and the subsequent paper P clogging of the ink ejection port 18 is reduced or prevented.

Here, in the present embodiment, the controller 110 uses a pattern (combination) of a plurality of opening groups 82, in the A direction, used for flushing in one cycle of the first conveyor belt 8, determined according to the size of the paper P to be used. The size of the paper P to be used can be recognized by the controller 110 based on the information stored in the storage unit 28 (the size information of the paper P input by the operation panel 27a). Note that the pattern of the opening group 82 is worded differently from the placement pattern of the paper P described later.

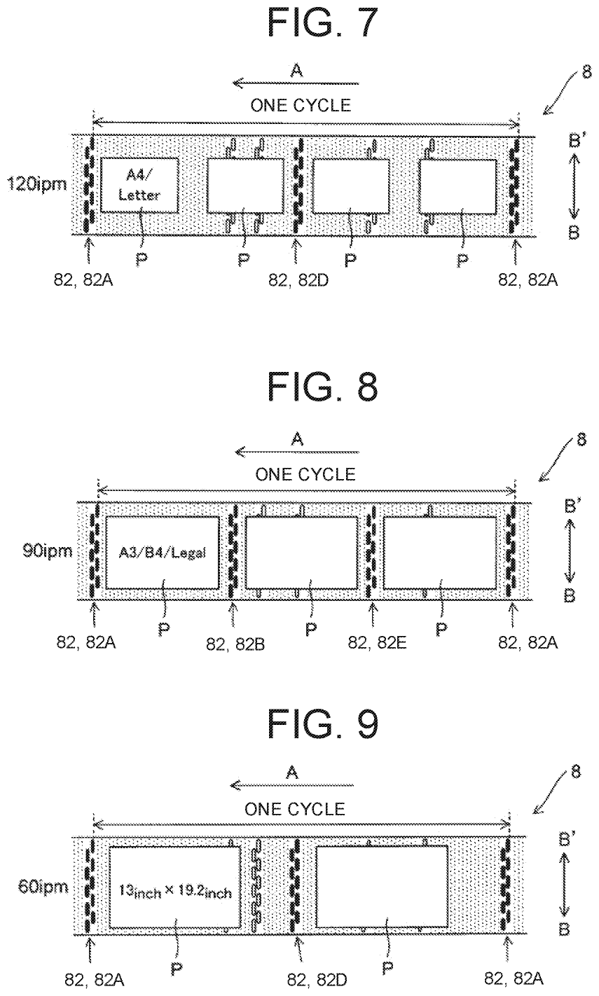

FIGS. 6 to 9 each illustrate an example of a pattern of the opening group 82 for each paper P. For example, when the paper P to be used is A4 size (horizontally placed) or letter size (horizontally placed), the controller 110 selects the pattern of the opening group 82 shown in FIG. 6. That is, out of the six opening groups 82 shown in FIG. 5, the controller 110 selects the opening groups 82A, 82C, and 82F as the opening groups 82 to be used for flushing. When the paper P to be used is A4 size (vertically placed) or letter size (vertically placed), out of the six opening groups 82 as shown in FIG. 7, the controller 110 selects the opening groups 82A and 82D as the opening groups 82 to be used for flushing. When the paper P to be used is A3 size, B4 size or legal size (all vertically placed), out of the six opening groups 82 the controller 110 selects the opening groups 82A, 82B, 82E as the opening groups 82 to be used for flushing, as shown in FIG. 8. When the paper P to be used has a size of 13 inches×19.2 inches, out of the six opening groups, the controller 110 selects groups 82A and 82D as the opening groups 82 to be used for flushing, 82 as shown in FIG. 9. Note that in each drawing, the openings 80 of the opening group 82 belonging to the above pattern are shown in black for convenience.

Then, the controller 110 causes the recording heads 17a to 17c to execute flushing at the time when the opening group 82, positioned in the determined pattern, faces the recording heads 17a to 17c due to the traveling of the first conveyor belt 8. Here, the traveling speed of the first conveyor belt 8 (paper conveyance speed), the interval between the opening groups 82A to 82E, and the positions of the recording heads 17a to 17c with respect to the first conveyor belt 8 are all known. Therefore, if the surface state detection sensor 24 (or the belt sensor 25) detects that an opening group 82 (for example, the opening group 82A), serving as a reference, has passed due to the traveling of the first conveyor belt 8, it is possible to know after how many seconds from the time of detection whether an opening groups 82A to 82E will pass through positions that face the recording heads 17a to 17c. Therefore, based on the detection result of the surface state detection sensor 24, the controller 110 causes the recording heads 17a to 17c to execute flushing at the time when the opening group 82, positioned in the pattern determined above, faces the recording heads 17a to 17c.

Further, the controller 110 controls the supply of the paper P to the first conveyor belt 8 so as to be offset in the A direction with respect to the opening group 82, which is positioned in the determined pattern. That is, the controller 110 supplies the paper P using the pair of registration rollers 13 between the plurality of opening groups 82 arranged in the A direction in the above pattern on the first conveyor belt 8.

For example, when the paper P to be used is A4 size (horizontally placed) or letter size (horizontally placed) as shown in FIG. 6, the controller 110 controls the pair of registration rollers 13 to supply the paper P at specific supply times onto the first conveyor belt 8 two sheets of paper P are arranged between the opening group 82A and opening group 82C and two sheets of paper are arranged between opening group 82C and the opening group 82F, and one sheet of paper is placed between opening group 82F and opening group 82A (in the following cycle). At this time, the controller 110 controls the pair of registration rollers 13 to supply the paper P onto the first conveyor belt 8 so each paper P can be arranged at a position separated by a specific distance or more in the A direction (including both the upstream side and the downstream side) from the opening groups 82A, 82C, and 82F, which are positioned in a pattern on the first conveyor belt 8. The specific distance is set to 10 mm as an example.

Here, the supply times of the paper P by the pair of registration rollers 13 can be determined by the controller 110 based on the detection result of the surface state detection sensor 24 (or the belt sensor 25). For example, when the surface state detection sensor 24 detects that an opening group 82 (for example, the opening group 82A), serving as a reference, has passed due to the traveling of the first conveyor belt 8, the controller 110 can determine how many seconds from the time of detection the paper P should be supplied to the first conveyor belt 8 by the pair of registration rollers 13 to arrange the paper P at each position shown in FIG. 6. Therefore, the controller 110 determines the supply times of the paper P based on the detection result of the surface state detection sensor 24, and controls the pair of registration rollers 13 so that the paper P is supplied at the determined supply times. As a result, the paper P can be arranged at each position shown in FIG. 6 on the first conveyor belt 8 at approximately equal intervals. In the example in FIG. 6, five sheets of paper P can be conveyed in one cycle of the first conveyor belt 8, and a number of prints (productivity), on the paper P per minute, of 150 ipm (images per minute), can be achieved.

When the paper P to be used is A4 size (vertically placed) or letter size (vertically placed), the controller 110 controls the pair of registration rollers 13 to supply the paper P at a specific supply times onto the first conveyor belt 8 to arrange two sheets of paper P between an opening group 82A and an opening group 82D, and to arrange two sheets of paper P between the opening group 82D and the opening group 82A (in the following cycle), on the first conveyor belt 8, as shown in FIG. 7. In the example in FIG. 7, four sheets of paper P can be conveyed in one cycle of the first conveyor belt 8, and a productivity of 120 ipm can be achieved.

When the paper P to be used is A3 size, B4 size or legal size (all vertically placed), as shown in FIG. 8, the controller 110 controls the pair of registration rollers 13 to supply the paper P at specific supply times onto the first conveyor belt 8 so one sheet of paper P is arranged between the opening group 82B, one sheet of paper P is arranged between the opening group 82B and the opening group 82E, and one sheet of paper P is arranged between the opening group 82E with the first conveyor belt 8 and (in the following cycle) so that one sheet of paper P is arranged between the opening group 82A and the opening group 82A. In the example in FIG. 8, three sheets of paper P can be conveyed in one cycle of the first conveyor belt 8, and a productivity of 90 ipm can be achieved.

When the paper P to be used has a size of 13 inches×19.2 inches as shown in FIG. 9, the controller 110 controls the pair of registration rollers 13 to supply the paper P at specific supply times onto the first conveyor belt 8 to arrange one sheet between the opening group 82A and the opening group 82D so that one sheet of paper P is arranged between the opening group 82D and the opening group 82A (in the following cycle) In the example in FIG. 9, two sheets of paper P can be conveyed in one cycle of the first conveyor belt 8, and a productivity of 60 ipm can be achieved.

That is, as shown in FIGS. 6 to 9, the pattern of the opening group 82 used for flushing is determined according to the size of the paper P that is being used and the placement pattern of the paper P is determined and positioned to be offset from the opening group 82 in the A direction. From this, the placement pattern of the paper P placed on the first conveyor belt 8 is determined according to the size of the paper P being used.

3. Control of Supply of Paper Based on the Detection of Waste on the First Conveyor Belt

Next, control of supply of paper P to the first conveyor belt 8 of this embodiment will be described. In the present embodiment, even in the case where a portion of the ink ejected at the time of flushing does not pass through the openings 80 and lands around the periphery of the openings 80 on the first conveyor belt 8 and the first conveyor belt 8 becomes soiled, in order to avoid a situation where the paper P to be supplied next becomes soiled the supply of the paper P onto the first conveyor belt 8 is controlled in the following manner. The periphery of the openings 80 include at least one of a position offset in the belt width direction (BB′ direction) relative to the openings 80 and a position offset in the paper conveyance direction (A direction) relative to the openings 80.

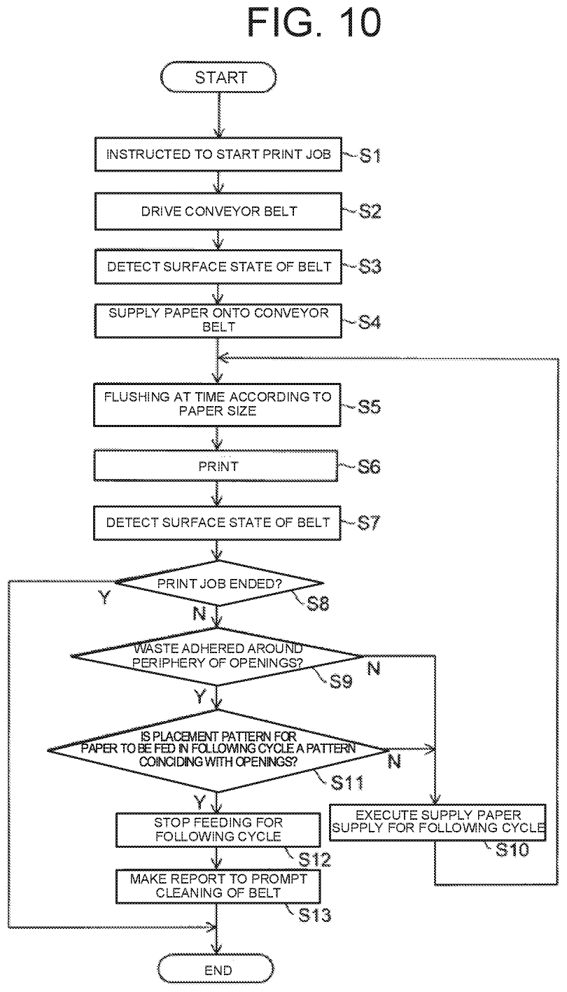

FIG. 10 is a flowchart showing the flow of processing by control of supply of the paper P of the present embodiment. First, when instructed to start a print job by an operation of the operation panel 27a (see FIG. 4) or reception of a print command from an external terminal (such as a PC) (S1), the controller 110 drives the drive roller 6a to run the first conveyor belt 8 (S2). The first revolution of the first conveyor belt 8 with reference to the detection position of the surface state detection sensor 24 is defined here as the first cycle. Then, in the first cycle of the first conveyor belt 8, when the surface state detection sensor 24 detects the surface state around the periphery of the openings 80 of each opening group 82 of the first conveyor belt 8 before flushing (S3), the controller 110 causes the supply of the paper P onto the first conveyor belt 8 by the recording medium supply mechanism 30. That is, the paper feeder 3 sequentially conveys the paper P from the paper feed cassette 2 (see FIG. 1) to the pair of registration rollers 13, and the pair of registration rollers 13 supplies the paper P at a specific time toward the first conveyor belt 8 (S4). It is assumed that at the point in time of the start of the first conveyor belt 8 run in S2, the flushing has not yet been performed and there is no waste on the first conveyor belt 8.

Note that in S3, the surface state detection sensor 24 also detects the passage of each opening group 82 due to the running of the first conveyor belt 8. On the other hand, the controller 110 recognizes the size of the paper P to be used in advance by referring to the storage unit 28. Accordingly, in S4, with the opening group 82 detected by the surface state detection sensor 24 as a reference (for example, opening group 82A), the controller 110 controls the recording medium supply mechanism 30 (paper feeder 3, the pair of registration rollers 13) causing the paper P to be supplied in such a way that the paper P is placed onto the first conveyor belt 8 in a placement pattern according to the size of the paper P (see, for example, FIGS. 6 to 9).

Next, the controller 110 causes the recording heads 17a to 17c to execute flushing at a time corresponding to the size of the paper P (S5). For example, if the paper P to be used is A4 size (horizontal), as shown in FIG. 6, at a time when the openings 80 included in the opening groups 82A, 82C, and 82F face the recording heads 17a to 17c in order by the running of the first conveyor belt 8, ink is ejected from the ink ejection ports 18 of the recording heads 17a to 17c. In addition, at the time when the paper P, supplied to and placed on the first conveyor belt 8 in S4, faces the recording heads 17a to 17c by the running of the first conveyor belt 8, the controller 110 causes ink to be ejected from the ink ejection ports 18 of the recording heads 17a to 17c based on the image data to form an image on the paper P (S6). The time of flushing in S5 and the time of the image formation (printing) on the paper P in S6 are determined by the positional relationship in the A direction between the placed paper P and the opening group 82 used for flushing (by which one is on the downstream side), and may be reversed depending on the positional relationship.

After the printing is ended in S6, the surface state detection sensor 24 again detects the surface state of the first conveyor belt 8 (S7). The detection at S7 is in the second cycle of the first conveyor belt 8. In other words, in S7, the detection of the opening group 82A or the like by the surface state detection sensor 24 is the second time from the start of the running of the first conveyor belt 8. The paper P supplied to the first conveyor belt 8 in the first cycle of the first conveyor belt 8 and on which image formation has been performed, after completing the detection (such as skew detection) by the surface state detection sensor 24, is conveyed to the second conveyance unit 12 (see FIG. 3) and discharged.

Next, the controller 110 determines whether the print job has ended (S8), and if the print job has ended, the controller ends the series of processes. On the other hand, if the print job has not been ended, the controller 110 determines whether waste is adhered to the area around the periphery of the openings 80 of the first conveyor belt 8 (S9), based on the surface state of the first conveyor belt 8 before and after the execution of the flushing, the detection result at S3 and the detection result at S7 by the surface state detection sensor 24. For example, in S9, when the difference between the amount of light received of the reflected light, detected in S3 by the surface state detection sensor 24 and the amount of light received of the reflected light detected in S7 is equal to or greater than a threshold value, the controller 110 can determine that waste is adhered around the periphery of the openings 80 of the first conveyor belt 8, and when the difference is less than the threshold value, can determine that there is no waste adhered around the periphery of the openings 80.

In addition, the waste detected here is basically the ink that was ejected during flushing. However, there is also a possibility that ink ejected in image formation on the paper P or waste adhering to other objects may be detected. In any case, since the detected waste may cause the paper P to become soiled, processing occurs as follows.

If it is determined in S9 that waste is not adhered around the periphery of the openings 80, in the following cycle (second cycle) after the cycle (first cycle) of the first conveyor belt 8 in which flushing was performed in S5, the controller 110 causes the execution of supply of the paper P onto the first conveyor belt 8 by the recording medium supply mechanism 30 (S10), and thereafter repeats the process from S5 onwards. If there is no waste adhered around the periphery of the openings 80, there is no risk of the paper P being soiled due to the first conveyor belt 8, regardless of whether the placement pattern of the paper P supplied in the second cycle of the first conveyor belt 8 is a pattern coinciding with the openings 80.

On the other hand, if it is determined at S9 that the above-described waste is adhered around the periphery of the openings 80, the controller 110 determines whether the placement pattern according to the size of the paper P in the second cycle of the first conveyor belt 8 is a pattern that coincides with the openings 80 (S11). If it is determined at S11 that the placement pattern is not a pattern coinciding with the openings 80, the process moves directly to S10 described above, and the controller 110 causes the execution of supply of the paper P onto the first conveyor belt 8 by the recording medium supply mechanism 30 in the second cycle of the first conveyor belt 8. Thereafter, the process from S5 onwards is repeated.

For example, when the controller 110 determines that waste is adhered around the openings 80 of the opening group 82D in FIG. 5, and the size of the paper P to be supplied in the second cycle of the first conveyor belt 8 is A4 size (vertically placed), as shown in FIG. 7, since the placement pattern of the paper P does not coincide with the openings 80, the controller 110 causes the execution of supply of the paper P onto the first conveyor belt 8 by the recording medium supply mechanism 30. Even when the size of the paper P supplied in the second cycle is 13 inches×19.2 inches, since the above-mentioned placement pattern of the paper P is not a pattern coinciding with the openings 80 (see FIG. 9), the supply of the paper P to the first conveyor belt 8 is executed in the same manner as described above. Further, when the controller 110 determines that waste is adhered around the periphery of the openings 80 of the opening group 82F in FIG. 5 and the size of the paper P to be supplied in the second cycle of the first conveyor belt 8 is A4 size (horizontal), as shown in FIG. 6, since the placement pattern of the paper P does not coincide with the openings 80, the controller 110 causes execution of the supply of the paper P onto the first conveyor belt 8 by the recording medium supply mechanism 30.

When the controller 110 determines that waste is adhered around the periphery of the openings 80 of the opening group 82A in FIG. 5, for a paper P of any size supplied in the following cycle of the first conveyor belt 8, the placement pattern is not a pattern coinciding with the openings 80 described above (see FIGS. 6 to 9). In this case, in the second cycle of the first conveyor belt 8, the recording medium supply mechanism 30 executes the supply of any size of paper P onto the first conveyor belt 8.

On the other hand, if it is determined at S11 that the upper placement pattern is a pattern coinciding with the openings 80, in the following cycle of the first conveyor belt 8, the controller 110 stops the supply of the paper P onto the first conveyor belt 8 by the recording medium supply mechanism 30 (S12). For example, when the controller 110 determines that waste is adhered around the periphery of the openings 80 of the opening group 82C in FIG. 5, and the size of the paper P supplied in the second cycle of the first conveyor belt 8 is A4 size (vertically placed), as shown in FIG. 7, since the placement pattern of the paper P is a pattern that coincides with the openings 80, the controller stops the supply of the paper P onto the first conveyor belt 8 by the recording medium supply mechanism 30.

Thereafter, the controller 110 causes the reporting unit 27 to report to the outside that the first conveyor belt 8 needs to be cleaned (S13). For example, the report is given to the user by the message being displayed on the operation panel 27a: “Please clean the first conveyor belt 8 because ink may have adhered to it.” or by outputting the above message by voice from the speaker 27b. The user can take measures such as cleaning the first conveyor belt 8 or replacing the first conveyor belt 8 if necessary, after receiving the report described above.

As described above, based on the detection results of the surface state detection sensor 24 before and after the execution of flushing by the recording heads 17a-17c, the controller 110 determines whether the ink discharged during flushing is adhered as waste around the periphery of the openings 80 of the first conveyor belt 8 (S9) and based on the presence or absence of adhered waste and a previously set placement pattern of the paper P to be supplied onto the first conveyor belt in the following cycle (e.g., the second cycle) after the cycle in which the flushing was executed (e.g., the first cycle), in the following cycle the controller 110 executes or stops the supply of the paper P onto the first conveyor belt 8 by the recording medium supply mechanism 30 (S11, S10, S12).

During flushing, the ink discharged from the recording head 17a to 17c normally passes through the openings 80 of the first conveyor belt 8 and is collected by the ink receptacles 31Y to 31K. However, due to unintended circumstances such as, for example, a change in the speed of the first conveyor belt 8 or a change in the direction of the airflow between the recording heads 17a-17c and the first conveyor belt 8, the ink ejected from the recording heads 17a-17c at the time of the flushing may adhere as waste around the periphery of the openings 80 of the first conveyor belt 8.

According to the above-described control, even when the ink ejected from the recording heads 17a to 17c during flushing adheres around the periphery of the openings 80 of the first conveyor belt 8 due to the unintended circumstances described above and the first conveyor belt 8 is soiled, since the supply of the paper P onto the first conveyor belt 8 in the cycle following the flushing is executed or stopped in consideration of the placement pattern of the paper P, it is possible to avoid a situation in which the paper P is soiled by the waste. It is of course true that if waste is not adhered around the periphery of the openings 80 as described above, the paper P will not be soiled even if supply of the paper P onto the first conveyor belt 8 is executed.

In particular, when the controller 110 determines, based on the detection result of the surface state detection sensor 24 that waste is adhered around the periphery of the openings 80 and the placement pattern of the paper P in the following cycle of the first conveyor belt 8 is a pattern coinciding with the openings 80, in the following cycle, the controller stops the supply of the paper P onto the first conveyor belt 8 by the recording medium supply mechanism 30. (S9, S11, S12). Due to this, situation in which the waste adhered to the first conveyor belt 8 at the time of flushing is transferred to the paper P and the paper P becomes soiled is effectively avoided.

Also, when the controller 110 determines, based on the detection result of the surface state detection sensor 24, that waste is adhered around the periphery of the openings 80 and the placement pattern of the paper P in the following cycle of the first conveyor belt 8 is a pattern that coincides with the openings 80, causes the reporting unit 27 to report to the outside that the first conveyor belt 8 needs to be cleaned (S13). This kind of report can externally prompt (the user) cleaning of the first conveyor belt 8 to prepare for the next, high quality image formation (without soiling paper P).

Also, when the controller 110 determines that waste is adhered around the periphery of the openings 80 based on the detection result of the surface state detection sensor 24, and when the placement pattern of the paper P in the following cycle of the first conveyor belt 8 is a pattern that is offset in the conveyance direction from the openings 80, the controller causes execution of the supply of the paper P onto the first conveyor belt 8 by the recording medium supply mechanism 30 in the following cycle (S9, S11, S10).

Even if the paper P is supplied to the first conveyor belt 8 in the following cycle of flushing, due to a shift in the placement position of the openings 80, which has waste adhered around the periphery, and the paper P, the possibility of the waste being transferred to the paper P is reduced. In particular, in this embodiment, as described above, the paper P is placed at a specific distance (such as 10 mm) in the direction A from the openings 80. By securing the above-described specific distance, the possibility of waste adhered around the periphery of the openings 80 being transferred to the paper P is sufficiently reduced. If the ink is adhered as waste at a position offset in the belt width direction with respect to the openings 80 on the first conveyor belt 8 at the time of the flushing, the above waste is naturally not transferred to the paper P due to the offset of the openings 80 and the placement position of the paper P in the conveyance direction. Therefore, by causing the execution of supply of the paper P to the first conveyor belt 8 as described above, the productivity can be maintained by performing image formation on the supplied paper P while reducing the generation of soiling due to the transfer of ink to the paper P.

In addition, the above-described placement pattern of the paper P is preset according to the size of the paper P (see FIGS. 6 to 9). Therefore, no matter what size of paper P is used, by executing or stopping the supply of the paper P to the first conveyor belt 8 in consideration of the placement pattern according to the size of the paper P, it is possible to avoid a situation in which the waste adhered around the periphery of the openings 80 is transferred to the paper P and the paper P becomes soiled.

Also, in the present embodiment, the surface state detection sensor 24 includes an image density sensor 24a that detects the presence or absence of the paper P on the first conveyor belt 8 (see FIG. 4). In this case, the sensor for detecting the presence or absence of the paper P on the first conveyor belt 8 and the sensor for detecting the condition of the surface of the first conveyor belt 8 can be combined into a single sensor (image density sensor 24a). Thus, for example, if an image density sensor 24a is originally installed in the apparatus, that image density sensor 24a can be effectively used as the surface state detection sensor 24. In this case, it is not necessary to provide a dedicated sensor for detecting the state of the surface of the first conveyor belt 8, which can reduce the number of component parts of the apparatus and contribute to cost reduction.

Also in this embodiment, as shown in FIG. 5, the first conveyor belt 8 has a plurality of opening rows 81 in the A direction with openings 80 lined up in the belt width direction (BB′ direction) perpendicular to the conveyance direction (A direction) of the paper P. Therefore, in the first conveyor belt 8, the two opening rows 81 adjacent to each other in the A direction are positioned to be offset in the BB′ belt width direction so that a portion of the openings 80 appear to overlap one another when viewed along the A direction. In the configuration using the first conveyor belt 8, two surface state detection sensors 24 are provided along the BB′ direction. Then, one surface state detection sensor 24 (for example, the first image density sensor 24a₁) detects the surface state of the first conveyor belt 8 around the periphery of the openings 80 of one of either of the two rows 81 (for example, the opening row 81a) that are adjacent in the A direction. The other surface state detection sensor 24 (for example, the second image density sensor 24a₂) can also be used to detect the other opening row 81 (for example, the opening row 81b) to detect the surface state of the first conveyor belt 8 around the periphery of the openings 80.

As described above, two surface state detecting sensors 24 configured with the image density sensor 24a are provided in the BB′ direction to detect the position (particularly the presence or absence of skew) of the paper P placed on the first conveyor belt 8. In such a configuration in which it is possible to detect the skew of the paper P, one surface state detection sensor 24 detects the surface state around the openings 80 included in one opening row 81a, and the other surface state detection sensor 24 detects the surface state around the openings 80 included in the other opening row 81b. As a result, even in a configuration in which the openings 80 are in staggered positions in the first conveyor belt 8, it is possible to detect the presence or absence of adhered waste around the periphery of the openings 80 of each opening row 81a and 81b.

As described above, the first conveyor belt 8 also has a plurality of opening groups 82 having at least one row of opening rows 81, in the BB′ direction. Further, the opening groups 82 are irregularly positioned in the A direction in one cycle of the first conveyor belt 8. In the configuration of the first conveyor belt 8, the opening group 82 used for the flushing differs according to the size of the paper P, and the placement pattern is determined according to the size of the paper P. Therefore, for example, when the size of the paper P to be used is changed, the opening group 82 to be used for the flushing is also changed, and the paper P may be placed coinciding with the openings 80 of the opening group 82 that was used immediately before. In this case, if waste is adhered around the periphery of the openings 80, the paper P will be soiled by the transfer of the waste when placed. Therefore, a situation in which waste around the periphery of the openings 80 is transferred to the paper P and causes the paper P to become soiled is avoided and the control of supply of the paper P in the present embodiment in a configuration where image forming is performed using the first conveyor belt 8 having a placement pattern of the paper P determined by the opening groups 82 being irregularly positioned in the A direction, becomes exceedingly efficient.

4 Other

In S12, the stopping of the supply of paper P onto the first conveyor belt 8 by the recording medium supply mechanism 30 is performed for all paper P to be supplied from the second cycle onward, but this control is not limited to this. For example, the controller 110 may determine, based on the placement pattern of the paper P to be used, whether the paper P will be placed in a position coinciding with the opening 80 having waste adhered around the periphery, and stop feeding of paper P by the first conveyor belt 8 only when coinciding with the openings 80, and to cause execution of feeding of the paper P placed in other positions

For example, in the first cycle of the first conveyor belt 8, an A4 size (horizontally placed) paper P is supplied, flushing and image formation are performed, and the controller 110 determines that waste is adhered around the periphery of the openings 80 of the opening group 82C due to the flushing. Then, when the size of the paper P to be supplied is A4 size (vertically placed) in the second cycle of the first conveyor belt 8, the paper P is not supplied onto the first conveyor belt 8 at a time that coincides with the opening group 82C in the second cycle (skipping the feeding of one sheet of paper P), and the paper P may be supplied and placed in other positions onto the first conveyor belt 8. In this case, the number of sheets of paper P to be conveyed in the second cycle of the first conveyor belt 8 becomes three, and the number of sheets of paper P to be conveyed is reduced by one compared with the number of sheets shown in FIG. 7 (four sheets), but by stopping the supply of the paper P that coincides with the opening group 82C, it is possible to avoid the situation where the paper P is soiled by the transfer of ink. On the other hand, since image formation can be performed on the paper P that is placed in other positions, productivity can be improved compared with the control that stops feeding of all the paper P.

The controller 110 may determine in S3 whether there is adhesion of waste such as ink on the first conveyor belt 8 based on the detection result (amount of light received) of the surface state at the surface state detection sensor 24. Then, when it is determined that waste is adhered to the belt, S4 to S11 may be skipped, and the process may move directly to S12 and thereafter may make a report in order to prompt cleaning of the belt in step 13.

The first conveyor belt 8 is not limited to the configuration in which the opening group 82 is irregularly positioned in the A direction as described above. For example, the first conveyor belt 8 may have a configuration in which the opening groups 82 are positioned at equal intervals in the A direction.

In the above, the case where the paper P is attracted to the first conveyor belt 8 by negative pressure suction and conveyed has been described. However, the first conveyor belt 8 may be charged and the paper P may be electrostatically attached to the first conveyor belt 8 and conveyed (electrostatic attachment method).

In the above, an example of using a color printer that records a color image using four color inks as an inkjet recording apparatus has been described, but even when a monochrome printer that records a monochrome image using black ink is used, it is possible to apply control of supply of the paper P as described in the present embodiment.

The present disclosure can be applied to an inkjet recording apparatus that ejects ink onto a recording medium to record an image.

What is claimed is:

1. An inkjet recording apparatus comprising:
a recording head having a plurality of nozzles that eject ink;
an endless conveyor belt that conveys a recording medium to a position facing the recording head;
a recording medium supply mechanism that supplies the recording medium onto the conveyor belt;
a surface state detection sensor that detects a surface state of the conveyor belt; and
a controller that controls the recording medium supply mechanism, wherein
the conveyor belt includes a plurality of openings in a conveyance direction of the recording medium that allow the ink to pass through when the recording head executes flushing that ejects ink at times different from the times that contribute to image formation on the recording medium, and
the controller determines whether waste is adhered around the periphery of the openings of the conveyor belt based on the detection result of the surface state detection sensor before and after the recording head executes flushing, and based on the presence or absence of waste and a previously set placement pattern of the recording medium to be supplied onto the conveyor belt in a cycle following a cycle in which flushing was executed, the controller causes the supply of the recording medium onto the conveyor belt, by the recording medium supply mechanism, to execute or to stop in the following cycle.

2. The inkjet recording apparatus according to claim 1, wherein when the controller determines that waste is adhered around the periphery of the openings based on the detection result of the surface state detection sensor, and when the placement pattern in the following cycle is a pattern coinciding with the openings, the controller causes the supply of the recording medium onto the conveyor belt, by the recording medium supply mechanism, to stop in the following cycle.

3. The inkjet recording apparatus according to claim 2 further comprising a reporting unit, wherein the controller determines that waste is adhered around the periphery of the openings based on the detection result of the surface state detection sensor, and when the placement pattern in the following cycle is a pattern coinciding with the openings, the controller causes the reporting unit to report to the outside that the conveyor belt needs to be cleaned.

4. The inkjet recording apparatus according to claim 1, wherein when the controller determines that waste is adhered around the periphery of the openings based on the detection result of the surface state detection sensor, and when the placement pattern in the following cycle is a pattern that is offset from the openings, the controller causes the execution of supply of the recording medium onto the conveyor belt by the recording medium supply mechanism in the following cycle.

5. The inkjet recording apparatus according to claim 1, wherein the placement pattern of the recording medium is set according to a size of the recording medium.

6. The inkjet recording apparatus according to claim 1, wherein the surface state detection sensor comprises an image density sensor that detects the presence or absence of the recording medium on the conveyor belt.

7. The inkjet recording apparatus according to claim 6, wherein
the conveyor belt has, at a plurality of locations in the conveyance direction, opening rows, which are the openings lined up in a belt width direction perpendicular to the conveyance direction of the recording medium in the conveyor belt,
two opening rows adjacent to each other in the conveyance direction in the conveyance belt are positioned to be offset in the belt width direction so that a portion of the openings appear to overlap one another when viewed along the conveyance direction, and
the surface state detection sensor includes two surface state detection sensors along the belt width direction, one surface state detection sensor detecting a surface state of the conveyor belt around the openings included in one opening row among the two opening rows that are adjacent to each other in the conveyance direction, and the other surface state detection sensor detecting a surface state of the conveyor belt around the openings included in the other opening row.

8. The inkjet recording apparatus according to claim 1, wherein
the conveyor belt has, at a plurality of locations in the conveyance direction, opening groups having rows of openings in which the openings are lined up in a belt width direction perpendicular to the conveyance direction of the recording medium on the conveyor belt, and
the opening groups are irregularly positioned in the conveyance direction in one cycle of the conveyor belt
